(19) United States
(12) Patent Application Publication
(10) Pub. No.: US 2016/0125455 A1
(43) Pub. Date: May 5, 2016

(54) SHARING REVENUE GENERATED FROM PRESENTING CONTENT TO A GROUP OF ONLINE SYSTEM USERS SPECIFIED BY A THIRD-PARTY SYSTEM WITH THE THIRD PARTY SYSTEM

(71) Applicant: Facebook, Inc., Menlo Park, CA (US)

(72) Inventors: Keyun Tong, Menlo Park, CA (US); Yi Huang, Pleasanton, CA (US)

(21) Appl. No.: 14/528,170

(22) Filed: Oct. 30, 2014

(51) Int. Cl. G06Q 30/02

(52) U.S. Cl. CPC G06Q 30/0251; G06Q 30/0277; G06Q 30/0274; G06Q 30/0275

(57) ABSTRACT

An online system receives information describing a target group of online system users from a third party system as well as an amount of compensation to the third party system if the target group is used to select content for an online system user. If a content item is identified as eligible for presentation to a viewing user because the viewing user is included in the target group, the online system modifies a bid amount associated with the content item based on the amount of compensation to the third party system. Based on the modified bid amount, the online system determines whether to present the content item to the viewing user. If the content item is presented to the viewing user, the online system modifies an amount charged to a user associated with the content item based on the amount of compensation to the third party system.

### BACKGROUND

This disclosure relates generally to presenting content to users of an online system, and more specifically to providing compensation to third party systems providing information to the online system used to select content for presentation to online system users.

An online system allows users to connect to and to communicate with other users of the online system. Users create profiles on an online system that are tied to their identities and include information about the users, such as interests and demographic information. The users may be individuals or entities such as corporations or charities. Content items are presented to various users by the online system to encourage users to interact with the online system.

But as the amount of content provided by the online system increases, users may be presented with an increasing amount of content in which the users have little interest. To provide users with content more likely to be relevant, content items may be associated with targeting criteria specifying characteristics of users eligible to be presented with the content item. This limits presentation of a content item to users having characteristics satisfying the targeting criteria.

While the online system maintains targeting criteria for identifying groups of users satisfying various targeting criteria, a third party system may provide information to the online system identifying groups of online system users. An entity may subsequently use the groups of users to identify users eligible to receive content items associated with the entity. For example, a content item may be associated with targeting criteria indicating the content item is eligible for presentation to users of the online system included in a group of users identified by a third party system. While a group of users specified by a third party system may be used to present content to online system users, in conventional online systems, the third party system does not receive compensation when it specifies a group subsequently used to select content, which may discourage the third party system from identifying additional groups of users to the online system.

### SUMMARY

An online system receives information from a third party system describing a target group including multiple users of the online system. Identifying a target group allows the third party system to specify a customized group of online system users to receive content. Information describing the target group may identify specific users of the online system or may include information specifying one or more characteristics of users of the online system in the target group. The online system stores the information describing the target group, which allows one or more users of the online system to use the target group to identify users of the online system eligible to be presented with a content item, such as an advertisement, associated with the user. For example, a content item is associated with targeting criteria specifying one or more characteristics, so the content item is eligible for presentation to online system users having characteristics satisfying at least a threshold number of the targeting criteria and is not eligible for presentation to online system users having characteristics satisfying less than the threshold number of the targeting criteria. Targeting criteria associated with a content item may specify a target group identified by a third party system so the content item is eligible for presentation to users included in the target group. In some embodiments, multiple target groups may be identified by a content item's targeting criteria to further refine the online system users eligible to be presented with the content item.

To allow a third party system that identified a target group used by the online system to receive compensation when the target group is used by the online system to present content to a viewing user of the online system, the third party system specifies an amount of compensation with the information identifying the target group. In one embodiment, the third party system specifies a percentage of compensation received by the online system if the target group was used by the online system to select content presented to the viewing user. For example, when identifying a target group, the third party system specifies an amount of compensation that is 15% of an amount received by the online system if the content item is presented to a viewing user because the viewing user was included in the target group.

When selecting content for presentation to the viewing user, the online system identifies content items associated with at least a threshold number of targeting criteria satisfied by characteristics of the viewing user. A content item associated with targeting criteria specifying a target group including the user is identified as eligible for presentation to the viewing user and is included in a selection process performed by the online system. The content item is associated with a bid amount specifying a maximum amount of compensation a user associated with the content item will provide the online system if the content item is presented to online system users. For example, the content item is an advertisement associated with a bid amount specified by an advertiser. The selection process includes multiple content items associated with bid amounts and eligible for presentation to the user. Based on the bid amounts associated with content items eligible for presentation to the viewing user, the selection process selects one or more content items for presentation to the viewing user. For example, the selection process is an auction or other method that ranks content items based on their associated bid amounts and selects content items having at least a threshold position in the ranking.

However, to account for the amount of compensation to be provided to the third party system associated with the target group specified by the targeting criteria of the content item, the online system modifies the bid amount associated with the content item based on the amount of compensation to the third party system if the content item is presented to the viewing user. In one embodiment, if the amount of compensation to the third party system is specified as a percentage, the online system modifies the bid amount by decreasing the bid amount by the specified percentage. For example, if the third party system identifying the target group included in the targeting criteria of the content item specifies an amount of compensation of 15% and the bid amount associated with the content item is $1.00, the online system decreases the bid amount by 15%, resulting in a modified bid amount of $0.85. Hence, the modified bid amount represents the amount of compensation received by the online system if the content item is presented. The modified bid amount, rather than the bid amount specified by the user associated with the content item, is associated with the content item when it is included in the selection process by the online system.

If the content item is selected for presentation to the viewing user by the selection process, an amount is associated with the content item by the selection process based on bid amounts associated with other content items included in the selection process. For example, the amount is based on the modified bid amount of the content item and bid amounts associated with one or more additional content items included in the selection process. The amount associated with the content item identifies the amount received by the online system from the user associated with the content item when the content item is presented to the viewing user. However, to provide the third party system identifying the target group included in the targeting criteria of the content item with the amount of compensation identified by the third party system without reducing the amount received by the online system from the user, the online system modifies the amount associated with the content item by the selection process based on the amount of compensation identified by the third party system along with the target group included in the targeting criteria of the content item. For example, the amount associated with the content item by the selection process is increased by a value based on the amount of compensation identified by the third party system. In one embodiment, the amount associated with the content item by the selection process is divided by a difference between 100% and a percentage specified by the amount of compensation identified by the third party system. Referring to the preceding example of a $1.00 bid amount and a 15% amount of compensation specified by the third party system, if the selection process associates an amount of $0.70 with the content item, the online system divides the amount of $0.70 by (1.00−0.15) to modify the amount, resulting in a modified amount of $0.82. The user associated with the content item is then charged the modified amount by the online system, which extracts the amount of compensation identified by the third party system from when the modified amount is received from the user. In the preceding example, the online system extracts 15% from the $0.82 amount ($0.12), and provides the third party system with the 15% of the $0.82. This allows the third party system to receive compensation when it identifies a target group used to select content for presentation to the viewing user without reducing the amount received by the online system from users associated with the selected content.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for allocating a portion of compensation received by an online system for presenting content to a third party system, in accordance with an embodiment.

FIG. 4 is a process flow diagram of an example of modifying a bid amount associated with a content item associated with targeting criteria identifying multiple target groups, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

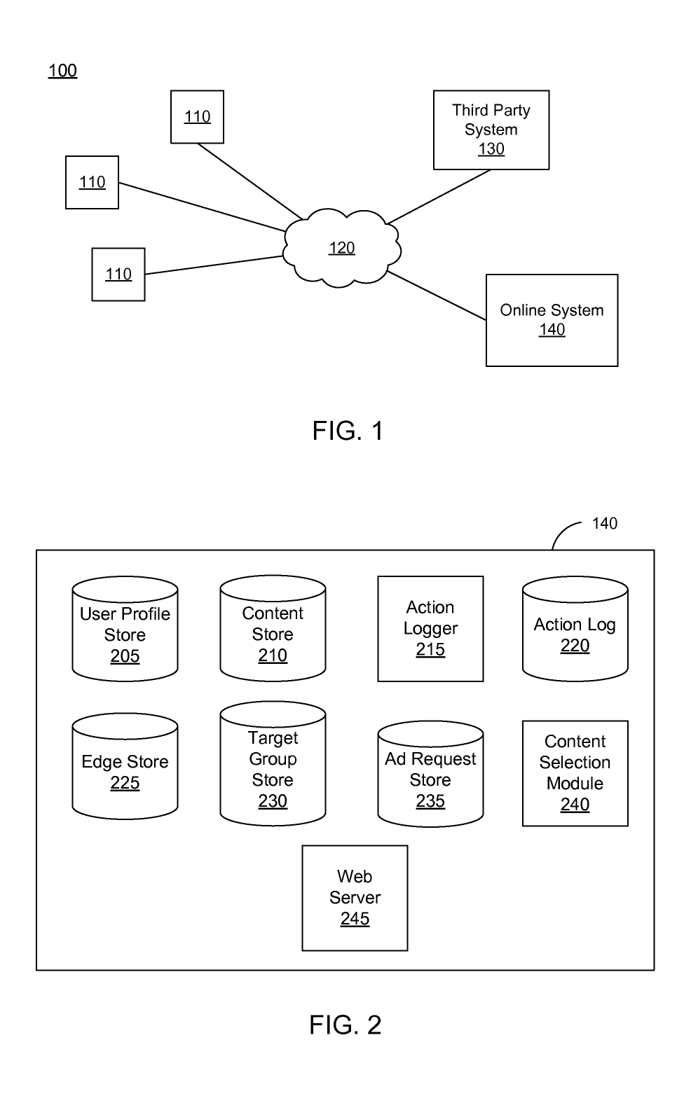

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, information describing a group of users of the online system 140, or information about an application provided by the third party system 130. In some embodiments, a third party system 130 may communicate information directly to the online system 140.

FIG. 2 is a block diagram of an architecture of the online system 140. For example, the online system 140 is a social networking system. The online system 140 shown in FIG. 2 includes a user profile store 205, a content store 210, an action logger 215, an action log 220, an edge store 225, a target group store 230, an advertisement (“ad”) request store 235, a content selection module 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220. In some embodiments, a third party system 130 may indirectly retrieve information from the user profile store 205, subject to one or more privacy settings associated with a user profile by a user, to identify a user profile in the user profile store 205 associated with a user of the third party system 130.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The target group store 230 includes information received from one or more third party systems describing target groups that each include one or more users of the online system 140, allowing a third party system 130 to identify a target group including various online system users to the online system 140. Information describing a target group may identify specific users of the online system 140 or may include information specifying one or more characteristics of users of the online system 140 in the target group. Information included in the target group store 230 may specify an amount of compensation associated with a target group. The amount of compensation specifies an amount received by a third party system 130 that provided the information from the online system 140 when the target group is used by the online system 140 to select content. For example, the amount of compensation associated with a target group specifies a percentage of an amount received by the online system 140 that is provided to a third party system 130 when content is selected for presentation based on the target group. As an example, a third party system 130 specifies that, when inclusion in a target group specified by the third party system 130 is used to selected content for presentation to online system users, the third party system 130 receives 10% of compensation received by the online system 140 from users associated with the content selected for presentation based on the target group. This encourages third party systems 130 to provide information describing target groups to the online system 140 by providing the third party systems 130 with compensation for the target groups. Receiving descriptions of target groups from various third party systems 130 may allow the online system 140 to more specifically identify content for different online system users, which may allow the online system 140 to provide users with more customized content.

One or more advertisement requests (“ad requests”) are included in the ad request store 235. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented. For example, the bid amount specifies a monetary amount that the online system 140 receives from the advertiser if advertisement content in an ad request is displayed and the expected value is determined by multiplying the bid amount by a probability of the advertisement content being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The content selection module 240 selects one or more content items for communication to a client device 110 to be presented to a viewing user. Content items eligible for presentation to the viewing user are retrieved from the content store 210, from the ad request store 235, or from another source, by the content selection module 240, which selects one or more of the content items for presentation to the viewing user. A content item eligible for presentation to the viewing user is a content item associated with at least a threshold number of targeting criteria satisfied by characteristics of the viewing user or is a content item that is not associated with targeting criteria. In various embodiments, the content selection module 240 includes content items eligible for presentation to the viewing user in one or more selection processes, which identify a set of content items for presentation to the viewing user. For example, the content selection module 240 determines a measure of relevance of various content items to the user based on characteristics associated with the user by the online system 140 based on the user's affinity for different content items and selects content items for presentation to the user based on the determined measures of relevance. For example, the content selection module 240 selects content items having the highest measures of relevance or having at least a threshold measure of relevance for presentation to the user. Alternatively, the content selection module 240 ranks content items based on their associated measures of relevance and selects content items having the highest positions in the ranking or having at least a threshold position in the ranking for presentation to the user.

Content items selected for presentation to the user may include ad requests or other content items associated with bid amounts. The content selection module 240 uses the bid amounts associated with various content items when selecting content for presentation to the viewing user. In various embodiments, the content selection module 240 determines an expected value associated with various content items based on their bid amounts and selects content items associated with a maximum expected value or associated with at least a threshold expected value for presentation. An expected value associated with a content item represents an expected amount of compensation to the online system 140 for presenting a content item. For example, the expected value associated with an ad request is a product of the ad request's bid amount and a likelihood of the user interacting with the ad content from the ad request. The content selection module 240 may rank ad requests based on their associated bid amounts and select ad requests having at least a threshold position in the ranking for presentation to the user. In some embodiments, the content selection module 240 may rank both content items and ad requests in a unified ranking based on bid amounts associated with ad request and measures of relevance associated with content items and ad requests. Based on the unified ranking, the content selection module 240 selects content for presentation to the user. Selecting ad requests and other content items through a unified ranking is further described in U.S. patent application Ser. No. 13/545,266, filed on Jul. 10, 2012, which is hereby incorporated by reference in its entirety.

If a content item includes a target group specified by a third party system 130 in targeting criteria associated with the group and the target group is associated with an amount of compensation to the third party system 130, the content selection module 240 accounts for the amount of compensation to the third party system 130 when the content item is included in a selection process. To account for the amount of compensation to the third party system 130 when the target group is used to select content, the content selection module 240 modifies a bid amount associated with the content item based on the amount of compensation to the third party system 130 specifying the target group used to identify the content item as eligible for presentation to the viewing user. For example, if the content item is identified as eligible for presentation to the viewing user because the viewing user is included in the target group specified by the third party system 130 and included in the content item's associated targeting criteria, the content selection module 240 reduces the bid amount of the content item based on the amount of compensation to the third party system 130. In one embodiment, the amount of compensation to the third party system 130 is a percentage, so the content item modifies the bid amount associated with the content item by reducing the bid amount by the percentage. The content selection module 240 includes the content item in a selection process using the modified bid amount.

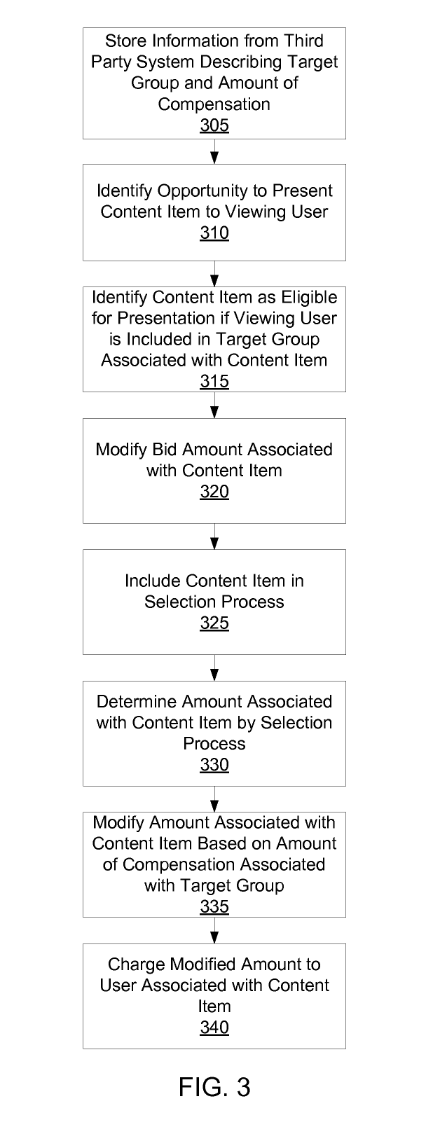

If the content item is selected based on the modified bid amount, the content selection module 240 associates an amount with the content item based on bid amounts associated with one or more additional content items included in a selection process with the content item. To provide the third party system 130 specifying the target group with its amount of compensation without reducing the compensation received by the online system 140 for presenting the content item, the content selection module 130 modifies the amount associated with the content item by a value based at least in part on the compensation received by the online system 140, as further described below in conjunction with FIG. 3. The online system 140 subsequently charges a user associated with the content item the modified amount, and provides the third party system 130 with its amount of compensation extracted from the modified amount when it is received by the online system 140. Accounting for an amount of compensation to a third party system 130 when selecting content for presentation to a viewing user is further described below in conjunction with FIG. 3. In some embodiments, if the third party system 130 provides information to the online system 140 describing a target group matching a pre-existing target group previously stored by the online system 140, so the target group describing a pre-existing target group for the content item, the online system does not provide compensation to the third party system 130. A pre-existing target group may be a target group generated by the online system 140 itself. For example if a third party system 130 provides information to the online system 140 matching a target group that the online system 140 generated and stored, the online system 140 does not provide compensation to the third party system 130.

The web server 245 links the online system 140 via the network 120 to the one or more client devices 110, as well as to the one or more third party systems 130. In some embodiments, the web server 245 links the online system 140 directly ton one or more third party systems 130. The web server 245 serves web pages, as well as other content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

### Allocating Compensation to a Third Party System Specifying a Target Group of Users

FIG. 3 is a flow chart of a method for allocating a portion of compensation received by an online system 140 for presenting content to a third party system 130. In other embodiments, the method may include different and/or additional steps than those described in conjunction with FIG. 3. Additionally, in some embodiments, the method may perform the steps described in conjunction with FIG. 3 in different orders.

The online system 140 receives and stores 305 information from a third party system 130 describing a target group that includes one or more users of the online system. Identifying a target group allows the third party system to specify a customized group of online system users to receive content. Information describing the target group may identify specific users of the online system 140 or may include information specifying one or more characteristics of users of the online system 140 in the target group. Information identifying the target group also specifies an amount of compensation to the third party system 130 if the target group is used to select content for presentation to one or more online system users. In one embodiment, the information identifying the target group specifies a percentage of compensation received by the online system 140 for presenting a content item for the third party system 130 to receive from the online system 140 if the target group was used to select the content item for presentation to one or more users. For example, the information identifying the target group specifies that that third party system 130 specifying the target group receives 15% of an amount received by the online system 140 for presenting a content item identified as eligible for presentation to an online system user because the online system user was included in the target group.

One or more users of the online system 140 are capable of accessing the stored information describing the target group, allowing users to include the target group in targeting criteria associated with content items, such as advertisements. Targeting criteria associated with a content item specifies one or more characteristics of users who are eligible to be presented with the content item. Users who are not associated with a least a threshold number of characteristics satisfying targeting criteria associated with a content item are not eligible to be presented with the content item. For example, a content item is eligible for presentation to users who are included in a target group specified by targeting criteria associated with the content item.

One or more content items associated with targeting criteria are maintained by the online system 140. A content item maintained by the online system is associated with targeting criteria specifying the target group described by the third party system 130. In some embodiments, the targeting criteria associated with the content item may specify multiple target groups each associated with one or more third party systems 130 or specify combinations of multiple target groups associated with one or more third party systems 130. For example, targeting criteria associated with the content item identifies a user included each of a set of target groups as eligible to be presented with the content item or identifies a user included in at least one target group from the set of target groups as eligible to be presented with the content item. Additionally, various content items maintained by the online system are associated with bid amounts, which specify a maximum amount of compensation a user associated with a content item (e.g., an advertiser) provides the online system 140 if the content item is presented to one or more online system users or if one or more online system users perform a type of interaction with the content item when it is presented. For example, content items maintained by the online system 140 include one or more advertisements associated with targeting criteria, which may specify the target group described by the third party system 130, and associated with bid amounts.

When the online system 140 identifies 310 an opportunity to present one or more content items to a viewing user, the online system identifies content items eligible for presentation to the viewing user. For example, when the online system 140 identifies an opportunity to present one or more advertisements to the viewing user, the online system identifies one or more advertisements associated with a least a threshold number of targeting criteria satisfied by characteristics of the viewing user. The content item associated with targeting criteria specifying the target group described by the third party system 130 is identified 315 as eligible for presentation to the viewing user if the viewing user is included in the target group. If the targeting criteria associated with the content item specifies a combination of target groups, the content item is identified 315 as eligible for presentation to the viewing user if the viewing user is included in the combination of target groups specified by the targeting criteria.

After identifying 315 the content item as eligible for presentation to the viewing user because the viewing user is included in the target group included in the targeting criteria, the online system modifies 320 the bid amount associated with the content item based on the amount of compensation to the third party system 130 if the target group is used to select content for presentation to one or more online system users. The online system 140 modifies 320 the bid amount by reducing the bid amount based on the amount of compensation to the third party system 130 if the target group is sued to select content for presentation to the viewing user. If the amount of compensation to the third party system 130 specifies a percentage, the online system 140 decreases the bid amount of the content item by the percentage. For example, if the third party system 130 identifying the target group included in the targeting criteria associated with the content item specifies an amount of compensation of 15% and the bid amount associated with the content item is $1.00, the online system 140 decreases the bid amount associated with the content item by 15%, resulting in a modified bid amount of $0.85. Hence, the modified bid amount represents the amount of compensation received by the online system if the content item is presented.

If the targeting criteria associated with the content item specifies multiple target groups and the content item is identified 315 as eligible for presentation to the viewing user because the viewing user is included in multiple target groups, the online system 140 modifies 320 the bid amount associated with the content item based on the number of target groups including the viewing user causing the content item to be identified 315 as eligible for presentation to the viewing user as well as the amounts of compensation associated with different target groups by third party systems 130 that specified the target groups. In one embodiment, each amount of compensation associated with a target group that caused identification of the content item as eligible for presentation to the viewing user is divided by a number of target groups including the user that cause the content item to be identified 315 as eligible for presentation to the viewing user. For example, if targeting criteria associated with the content item identify a combination of a target group and an additional target group, which each include the viewing user, the content item is identified 315 as eligible for presentation to the viewing user and the bid amount associated with the content item is modified 320 based on one-half the amount of compensation to the third party system 130 specifying the target group and one-half the amount of compensation to an additional third party system 130 specifying the additional target group. As a specific example, if a target group is associated with a third party system 130 receiving 15% of the amount of compensation received by the online system 140 and an additional target group is associated with the third party system 130 (or an additional third party system 130) receiving 20% of the amount of compensation received by the online system 140, if the content item is identified 315 as eligible for presentation to the viewing user because the viewing user is included in the target group and in the additional target group, the bid amount is reduced by (1/2)(15%) and (1/2)(20%), or 17.5%, as inclusion of the viewing user in each target group causes the content item to be identified 315 as eligible for presentation to the viewing user.

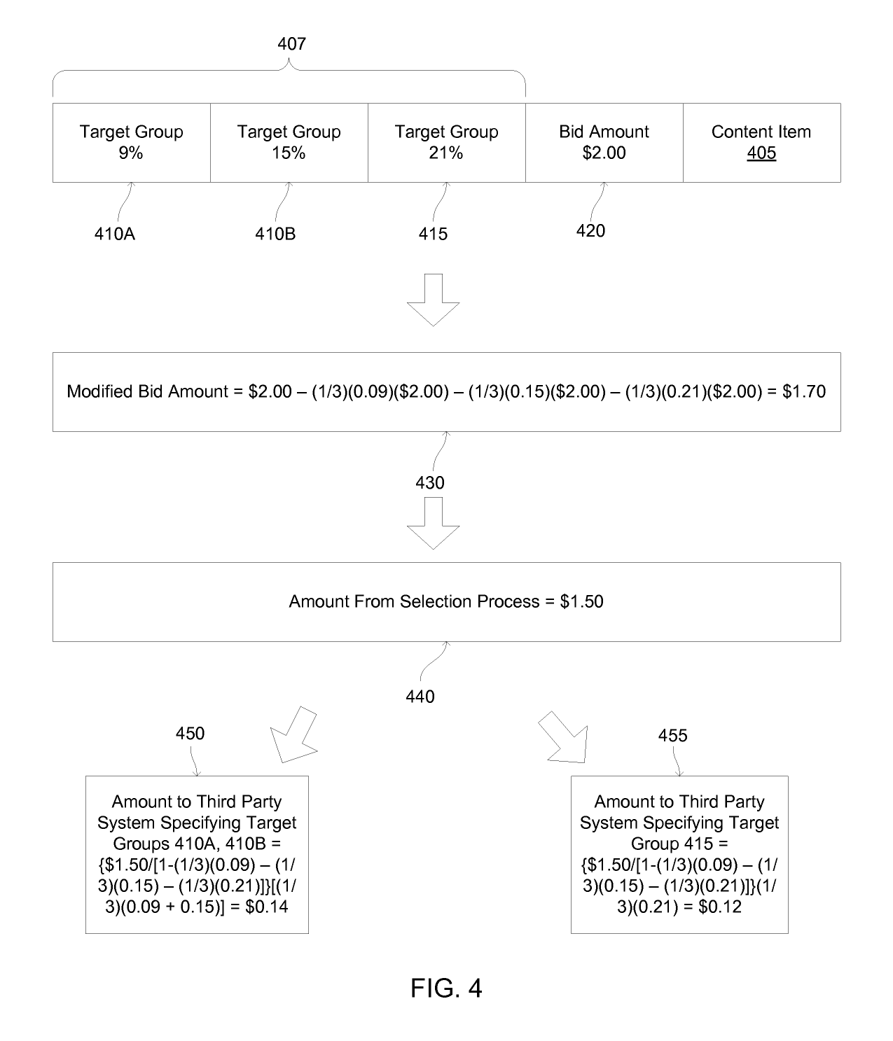

FIG. 4 shows an example of modifying a bid amount associated with a content item associated with targeting criteria identifying multiple target groups that are specified by one or more third party systems 130. In the example of FIG. 4, a content item 405 is associated with targeting criteria 407 and a bid amount 420. The targeting criteria 407 identify target group 410A, target group 410B, and target group 415. For purposes of illustration, target group 410A and target group 410B were specified by a third party system 130, while target group 415 was specified by an additional third party system 130. Additionally, in the example of FIG. 4, the targeting criteria 407 indicates that the content item 405 is eligible for presentation to a user who is included in target group 410A, target group 410B, and target group 415.

When the content item 405 is identified 315 as eligible for presentation to the viewing user because the viewing user is included in target group 410A, in target group 410B, and in target group 415, the bid amount 420 is modified 320 based on the amounts of compensation associated with target group 410A and target group 410B by the third party system 130 and by the amount of compensation associated with target group 415 by the additional third party system 130. In the example of FIG. 4, the third party system 130 specifies amounts of compensation of 9% and 15% of the compensation received by the online system 140 for presenting the content item 405 associated with target group 410A and target group 410B, respectively. Similarly, the additional third party system 130 specifies an amount of compensation of 21% of the amount of compensation received by the online system 140 associated with target group 415. Because the content item 405 is identified 315 as eligible for presentation to the viewing user because the viewing user is included in each of target group 410A, target group 410B, and target group 415, the online system 140 accounts for the number of target groups causing identification of the content item 405 as eligible for presentation to the viewing user when modifying 320 the bid amount 420. For example, the online system 140 reduces the amounts of compensation associated with each target group by a value that is inversely proportional to the number of target groups causing the content item to be identified 320 as eligible for presentation to the user and modifies 320 the bid amount 420 based on the reduced amounts of compensation. In the example of FIG. 4, the content item 405 is identified 315 as eligible for presentation to the viewing user because the viewing user is included in three target groups (target group 410A, target group 410B, and target group 415), so the online system 140 reduces each amount of compensation associated with the different target groups by ⅓. The reduced amounts of compensation are then combined, with the combined value used to reduce the bid amount 420, resulting in a modified bid amount 430. Hence, in the example of FIG. 4, the bid amount 420 of $2.00 is reduced by (1/3)(9%)+(1/3)(15%)+(1/3)(21%), or 15%, resulting in a modified bid amount 430 of $1.70. As further described below in conjunction with FIG. 3, the modified bid amount is subsequently used by the online system 140 to determine whether to present the content item 405 to the viewing user.

Referring to FIG. 3, after being identified 315 as eligible for presentation to the viewing user, the content item associated with targeting criteria specifying the target group is included 325 in a selection process using its modified bid amount. The selection process includes one or more additional content items identified as eligible for presentation to the viewing user and associated with additional bid amounts. Based on the bid amounts associated with content items eligible for presentation to the viewing user, the selection process selects one or more content items for presentation to the viewing user. For example, the selection process is an auction or other method that ranks content items based on their associated bid amounts and selects content items having at least a threshold position in the ranking. In various embodiments, the content item is an advertisement, and the selection process selects one or more advertisements for presentation to the viewing user based on bid amounts associated with advertisements included in the selection process; for example, advertisements having maximum bid amounts or having a threshold position in a ranking of advertisements based on bid amounts are selected. Using the modified bid amount associated with the content item in the selection process allows the online system 140 to account for the amount of compensation to be provided to the third party system 130 associated with the target group specified by the targeting criteria of the content item. Hence, the modified bid amount used in the selection process represents the amount of compensation received by the online system 140 if the content item is presented, so the selection process is based on the amounts received by the online system 140 for presenting content items.

If the content item associated with the targeting criteria specifying the target group is selected for presentation to the viewing user by the selection process, the online system 140 determines 330 an amount is associated with the content item by the selection process based on bid amounts associated with other content items included in the selection process. For example, the amount associated with the content item is based on the modified bid amount of the content item and bid amounts associated with one or more additional content items included in the selection process. The amount associated with the content item identifies the amount received by the online system 140 from the user associated with the content item when the content item is presented to the viewing user.

To provide the third party system 130 identifying the target group included in the targeting criteria of the content item with the amount of compensation identified by the third party system 130 without reducing the amount received by the online system 140 from the user associated with the content item, the online system 140 modifies 335 the amount associated with the content item by the selection process based on the amount of compensation to the third party system 130. For example, the amount associated with the content item by the selection process is increased by a value based on the amount of compensation identified by the third party system 130. In one embodiment, the amount associated with the content item by the selection process is divided by a difference between 100% and a percentage specified by the amount of compensation identified to the third party system 130. As an example, the bid amount associated with the content item is $1.00 bid amount and the third party system 130 specifies 15% of an amount received by the online system 130 if the target group is used to identify 315 the content item as eligible for presentation to the viewing user and the selection process associates a value of $0.70 with the content item, the online system 140 divides the value of $0.70 by (1.00−0.15) to modify 335 the amount, resulting in a modified amount of $0.82. However, in various other embodiments, the online system 140 modifies 335 the amount associated with the content item by the selection process based on any suitable value that is based at least in part on the amount of compensation to the third party system 130.

The online system 140 then charges 340 the user associated with the content item the modified amount. When the online system 140 receives the modified amount from the user associated with the content item, the online system 140 extracts the amount of compensation to the third party system 130 and provides the extracted amount to the third party system 130. Referring to the preceding example where the modified amount associated with the content item was $0.82, the online system 140 extracts 15% from the $0.82 when it is received, which results in $0.12 being extracted from the $0.82 and provides the third party system with the extracted 15% of the received amount; in this example, the online system 140 retains $0.70 from the user associated with the content item, which was the amount associated with the content item by the selection process. This allows the third party system 130 to receive the amount of compensation specified when the third party system 130 identifies a target group used to select content for presentation to the viewing user without reducing the amount received by the online system 140 from a user associated with a content item that used the target group as targeting criteria to identify users eligible to be presented with the content item.

Referring to the example of FIG. 4, if the modified bid amount 430 for the content item 405 of $1.70 causes the content item 405 to be selected by the selection process and associated, for purposes of illustration, with an amount 440 of $1.50 by the selection process, the online system 140 modifies 335 the amount 440 of $1.50 by a value based on the amounts of compensation associated with the target groups included in the targeting criteria 407 associated with the content item 405. For example, the amount 440 associated with the content item by the selection process is modified 335 based on the amounts of compensation associated with each target group identifying 315 the content item 405 as eligible for presentation and a total number of target groups that cause the content item 405 to be identified 315 as eligible for presentation to the viewing user. In the example of FIG. 4, the $1.50 amount associated with the content item 405 by the selection process is divided by [1−(0.09)/3−(0.15)/3−(0.21)/3)], where the amounts of compensation to third party systems specifying target group 410A, target group 410B, and target group 415 are reduced by a factor that is the inverse of the total number of target groups that caused identification of the content item 405 as eligible for presentation to the viewing user. Hence, in the example of FIG. 4, the online system 140 charges a user associated with the content item 405 of $1.76.

In the example of FIG. 4, when the online system 140 receives the amount of compensation of $1.76 from the user, the online system 140 extracts the amounts of compensation to provide to the third party system 130 that specified target group 410A and target group 410B as well as to the additional third party system 130 that specified target group 415. When determining the amount of compensation to the third party systems 130, the online system 140 also accounts for the total number of target groups causing identification of the content item as eligible for presentation to the viewing user. For example, the amount of compensation associated with a target group used to identify 315 the content item as eligible for presentation to the viewing user is reduced by a factor that is the inverse of the total number of target groups causing identification of the content item as eligible for presentation to the viewing user. In the example of FIG. 4, three target groups are used to identify 315 the content item 405 as eligible for presentation to the viewing user, so the amount of compensation associated with each target group is reduced by a factor of ⅓. Hence, the target group 130 that specified target group 410A and target group 410B receives ($1.76)(0.09/3) for use of target group 410A and receives ($1.76)(0.15/3) for use of target group 410B, resulting in third party system 130 receiving an amount 450 of $0.14 from the $1.76 received by the online system 140. Similarly, the additional target group 130 that specified target group 415 receives an amount 455 of (1.76)(0.21/3), or $0.12, of the $1.76 received by the online system 140.

### SUMMARY

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A method comprising:
storing, at an online system, information received from a third party system describing a target group including a plurality of users of the online system and identifying an amount of compensation to the third party system if the target group is used to select content for presentation to one or more users of the online system;
identifying an opportunity to present one or more advertisements to a viewing user of the online system;
identifying an advertisement associated with targeting criteria specifying the target group as eligible for presentation to the viewing user if the viewing user is included in the target group, the advertisement associated with a bid amount specifying an amount of compensation from a user associated with the advertisement to the online system if the advertisement is presented;
modifying the bid amount associated with the identified advertisement based on the amount of compensation to the third party system if the viewing user's inclusion in the target group causes the advertisement to be identified as eligible for presentation to the viewing user;
including the content item in a selection process using the modified bid amount, the selection process including one or more additional advertisements each associated with bid amounts;
determining an amount associated with the identified advertisement based at least in part on bid amounts associated with the one or more additional advertisements if the identified advertisement is selected by the selection process;
modifying the amount associated with the identified advertisement based on the amount of compensation to the third party system identified by the third party system; and
charging the modified amount associated with the identified advertisement to the user associated with the advertisement.

2. The method of claim 1, further comprising:
receiving the modified amount associated with the identified advertisement from the user associated with the advertisement;
extracting the amount of compensation to the third party system from the received modified amount; and
providing the amount of compensation to the third party system.

3. The method of claim 1, wherein the targeting criteria associated with the advertisement identifies one or more additional target groups, each additional target group associated with one or more additional third party systems.

4. The method of claim 3, wherein the advertisement is identified as eligible for presentation to the viewing user if the viewing user is included in at least a threshold number of target groups including the target group and the one or more additional target groups.

5. The method of claim 4, wherein modifying the bid amount associated with the identified advertisement comprises:
determining a number of target groups identified by the targeting criteria associated with the identified advertisement that cause the identified advertisement to be identified as eligible for presentation to the viewing user; and
modifying the bid amount associated with the identified advertisement based on the determined number of target groups and amounts of compensation to third party systems specifying each target group that caused the identified advertisement to be identified as eligible for presentation to the viewing user.

6. The method of clam 1, wherein the amount of compensation to the third party system if the target group is used to select content for presentation to one or more users of the online system comprises a percentage.

7. The method of claim 6, wherein modifying the bid amount associated with the identified advertisement comprises:
decreasing the bid amount associated with the identified advertisement by the percentage.

8. The method of claim 1,wherein modifying the amount associated with the identified advertisement based on the amount of compensation to the third party system identified by the third party system comprises:
increasing the amount associated with the identified advertisement by a value based at least in part on the amount of compensation to the third party system identified by the third party system.

9. A method comprising:
storing, at an online system, information received from a third party system describing a target group including a plurality of users of the online system and identifying an amount of compensation to the third party system if the target group is used to select content for presentation to one or more users of the online system;
identifying a content item associated with targeting criteria specifying the target group as eligible for presentation to the viewing user if the viewing user is included in the target group, the content item associated with a bid amount specifying an amount of compensation from a user associated with the content item to the online system if the content item is presented;
modifying the bid amount associated with the identified content item based on the amount of compensation to the third party system if the viewing user's inclusion in the target group causes the content item to be identified as eligible for presentation to the viewing user;
including the content item in a selection process using the modified bid amount, the selection process including one or more additional content items each associated with bid amounts;
determining an amount associated with the identified content item based at least in part on bid amounts associated with the one or more additional content items if the identified content item is selected by the selection process;
modifying the amount associated with the identified content item based on the amount of compensation to the third party system identified by the third party system; and
charging the modified amount associated with the identified content item to the user associated with the content item.

10. The method of claim 9, further comprising:
receiving the modified amount associated with the identified content item from the user associated with the content item;
extracting the amount of compensation to the third party system from the received modified amount; and
providing the amount of compensation to the third party system.

11. The method of claim 9, wherein the targeting criteria associated with the content item identifies one or more additional target groups, each additional target group associated with the third party system.

12. The method of claim 11, wherein the content item is identified as eligible for presentation to the viewing user if the viewing user is included in at least a threshold number of target groups including the target group and the one or more additional target groups.

13. The method of claim 12, wherein modifying the bid amount associated with the identified content item comprises:
determining a number of target groups identified by the targeting criteria associated with the identified content item that cause the identified content item to be identified as eligible for presentation to the viewing user; and
modifying the bid amount associated with the identified content item based on the determined number of target groups and amounts of compensation associated with each target group by the third party system that caused the identified content item to be identified as eligible for presentation to the viewing user.

14. The method of claim 13, wherein the bid amount associated with the identified content item is modified by a value that is inversely related to the determined number of target groups.

15. The method of clam 9, wherein the amount of compensation to the third party system if the target group is used to select content for presentation to one or more users of the online system comprises a percentage.

16. The method of claim 15, wherein modifying the bid amount associated with the identified content item comprises:
decreasing the bid amount associated with the identified content item by the percentage.

17. The method of claim 9,wherein modifying the amount associated with the identified content item based on the amount of compensation to the third party system identified by the third party system comprises:
increasing the amount associated with the identified content item by a value based at least in part on the amount of compensation to the third party system identified by the third party system.

18. A computer program product comprising a computer readable storage medium having instructions encoded thereon that, when executed by a processor, cause the processor to:
store, at an online system, information received from a third party system describing a target group including a plurality of users of the online system and identifying an amount of compensation to the third party system if the target group is used to select content for presentation to one or more users of the online system;
identify a content item associated with targeting criteria specifying the target group as eligible for presentation to the viewing user if the viewing user is included in the target group, the content item associated with a bid amount specifying an amount of compensation from a user associated with the content item to the online system if the content item is presented;
modify the bid amount associated with the identified content item based on the amount of compensation to the third party system if the viewing user's inclusion in the target group causes the content item to be identified as eligible for presentation to the viewing user;
include the content item in a selection process using the modified bid amount, the selection process including one or more additional content items each associated with bid amounts;
determine an amount associated with the identified content item based at least in part on bid amounts associated with the one or more additional content items if the identified content item is selected by the selection process;
modify the amount associated with the identified content item based on the amount of compensation to the third party system identified by the third party system; and
charge the modified amount associated with the identified content item to the user associated with the content item.

19. The computer program product of claim 18,wherein modify the amount associated with the identified content item based on the amount of compensation to the third party system identified by the third party system comprises:
increase the amount associated with the identified content item by a value based at least in part on the amount of compensation to the third party system identified by the third party system.

20. The computer program product of claim 17, wherein the computer readable storage medium further has instructions encoded thereon that, when executed by the processor, cause the processor to:
receive the modified amount associated with the identified content item from the user associated with the content item;
extract the amount of compensation to the third party system from the received modified amount; and
provide the amount of compensation to the third party system.
